(19) United States
(12) Patent Application Publication
(10) Pub. No.: US 2015/0341081 A1
(43) Pub. Date: Nov. 26, 2015

(54) METHOD AND APPARATUS FOR UPDATING FEXT COEFFICIENTS FOR G.FAST VECTORING WITH DISCONTINUOUS OPERATION

(71) Applicant: IKANOS COMMUNICATIONS, INC., Fremont, CA (US)

(72) Inventors: Murli Mohan RAO, Fremont, CA (US); Kevin D. FISHER, Palo Alto, CA (US)

(21) Appl. No.: 14/717,947

(22) Filed: May 20, 2015

Related U.S. Application Data
(60) Provisional application No. 62/000,872, filed on May 20, 2014.

(51) Int. Cl. H04B 3/32; H04L 5/14; H04L 12/12; H04M 11/06

(52) U.S. Cl. CPC H04B 3/32; H04M 11/062; H04L 5/1469; H04L 12/12

(57) ABSTRACT

In general, the present invention is related to methods and apparatuses for performing an efficient update of Far-End Cross Talk (FEXT) coefficients for use with Discontinuous Operation (DO) in G.fast systems. In embodiments, to maintain separate FEXT coefficient matrices for both the Regular Operation (RO) group and the smaller DO group, the updates to the DO coefficient matrix are performed independently from the updates to the RO coefficient matrix. In these and other embodiments, the updates are performed using LMS updates and known data symbols, and with the same frequency as the LMS updates to the RO coefficient matrix.

### CROSS-REFERENCE TO RELATED APPLICATIONS

This application claims the benefit under 35 USC 119(e) of prior co-pending U.S. Provisional Patent Application No. 62/000,872, filed May 20, 2014, the disclosure of which is hereby incorporated by reference in its entirety.

### FIELD OF THE INVENTION

The present invention relates generally to xDSL systems, and more particularly to methods and apparatuses for managing FEXT coefficient updates in G.fast systems supporting Discontinuous Operation.

BACKGROUND OF THE RELATED ART

In 2011, the ITU-T officially began a project to define advanced high speed transmission on twisted pair cables to address high speed transmission on short loop lengths (<250 m) at speeds up to approximately 1 Gb/s aggregate (sum of upstream and downstream rates). The result of this study is ITU-T Recommendation G.9701 (i.e. G.fast), which has since been adopted as a standard, and defines a transceiver specification based on time division duplexing (TDD) for the transmission of the downstream and upstream signals in a wide bandwidth of approximately 106 MHz and a symbol rate of approximately 48 kHz. This contrasts with prior standards such as VDSL2 having a 17.6 MHz bandwidth with a corresponding symbol rates of approximately 4 kHz and 30 MHz bandwidth with a corresponding symbol rate of 8 kHz.

In an effort to obtain power savings in a distribution point unit (DPU) with an option to operate with reverse power feed from the customer premises equipment (CPE), G.fast defines a scheme called discontinuous operation (DO). This allows transceivers on each link to “turn off” system processing to help scale the system power dissipation commensurate with the amount of data traffic being passed. By transmitting data in time slots when data is available and transmitting silence when there is no data available, the equipment power dissipation may be scaled directly with the available user payload data.

Although the power savings of DO is beneficial, it comes at the cost of requiring the vectoring system to maintain a matrix of Far End Crosstalk (FEXT) coefficients for all operating lines in the vectoring group, as well as a separate and distinct matrix of FEXT coefficients for only the lines in the DO group.

Conventionally, the DO FEXT coefficient sub-matrix of the lines in the DO group is mathematically derived from the full FEXT coefficient matrix of all lines in the system that operate during Regular Operation. This derivation involves matrix inversion/multiplies or simplifications thereof. Various proposals for this derivation include: Sckipio, “Power saving implications on vectoring—static allocation case,” Contribution ITU-T SG15/Q4 2012-11-4A-043, Chengdu, China, November 2012; Lantiq, “G.fast: Precoder update in support of discontinuous operation,” ITU-T SG15 Q4a contribution 2013-01-Q4-068, Geneva, Switzerland, January 2013; and Alcatel-Lucent, “G.fast: Solutions for Precoding in Discontinuous Operation,” ITU-T SG15, 2013-03-Q4-052, Red Bank, N.J., March, 2013. The contents of each of these references are incorporated herein in their entireties.

More particularly, vectoring systems such as G.fast initially perform a full estimation of the RO coefficient matrix every time any line joins or leaves the vectoring group. Thereafter, during Showtime, least mean squares (LMS) updates to the RO coefficient matrix are periodically performed to maintain or improve system performance.

In all of the conventional approaches, with every LMS update of the regular (N×N) matrix, in addition to initially deriving the DO coefficient matrix from the RO coefficient matrix, the DO sub-matrix needs to be re-derived, which can be computationally unfeasible. What is needed, therefore, is an alternative mechanism for performing LMS updates for DO sub-matrices that could be computationally more viable.

### SUMMARY OF THE INVENTION

In general, the present invention is related to methods and apparatuses for performing an efficient update of Far-End Cross Talk (FEXT) coefficients for use with Discontinuous Operation (DO) in G.fast systems. In embodiments, to maintain separate FEXT coefficient matrices for both the Regular Operation (RO) group and the smaller DO group, the updates to the DO coefficient matrix are performed independently from the updates to the RO coefficient matrix. In these and other embodiments, the updates are performed using LMS updates and known data symbols, and with the same frequency as the LMS updates to the RO coefficient matrix.

In accordance with these and other aspects, a method for managing a set of Far-End Cross Talk (FEXT) coefficients for a Discontinuous Operation (DO) group of lines in a G.fast communication system according to embodiments includes, during a DO transmission period, transmitting symbols on the DO group of lines and performing a least mean squares (LMS) update of the set of FEXT coefficients based on the symbols transmitted during the DO transmitted period.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 is a block diagram illustrating an example G.fast vectoring system supporting DO according to embodiments of the invention;

FIG. 2 is a block diagram illustrating an example DPU in accordance with embodiments of the invention;

FIG. 3 is a diagram illustrating example aspects of implementing DO in accordance with embodiments of the invention;

FIG. 4 is a diagram illustrating an example G.fast superframe having TDD Sync frames in accordance with aspects of the invention; and

FIG. 5 is a diagram illustrating example aspects of implementing DO coefficient matrix updates in accordance with embodiments of the invention.

### DETAILED DESCRIPTION OF THE PREFERRED EMBODIMENTS

The present invention will now be described in detail with reference to the drawings, which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements. Moreover, where certain elements of the present invention can be partially or fully implemented using known components, only those portions of such known components that are necessary for an understanding of the present invention will be described, and detailed descriptions of other portions of such known components will be omitted so as not to obscure the invention. Embodiments described as being implemented in software should not be limited thereto, but can include embodiments implemented in hardware, or combinations of software and hardware, and vice-versa, as will be apparent to those skilled in the art, unless otherwise specified herein. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

Notably, the terminology used in the present specification is driven by preferred embodiments based on the G.fast (G.9701) standard. However, the present invention is not limited to such embodiments, and the concepts of the invention are applicable to any time division duplexed multicarrier based system other than G.fast.

According to certain aspects, the present invention is directed to decoupling the updates to the DO sub-matrix of FEXT coefficients from the LMS updates performed for the full Regular Operation matrix of FEXT coefficients.

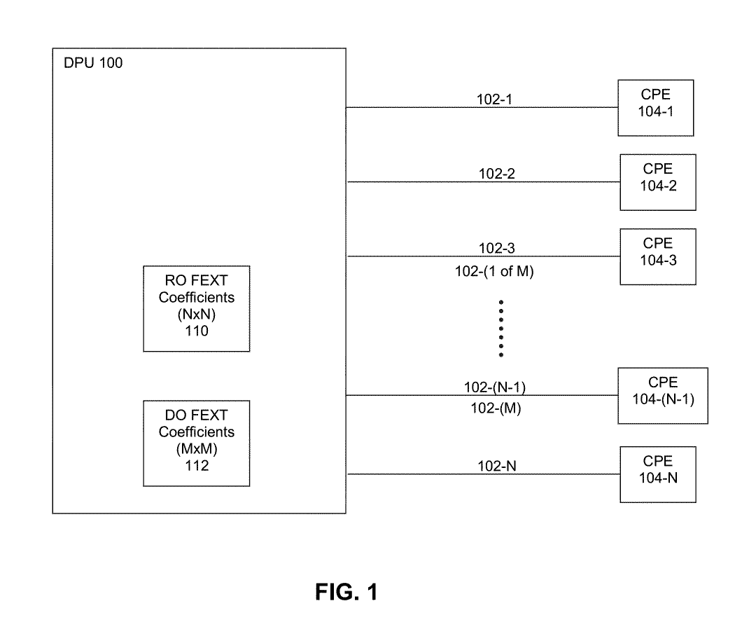

An example G.fast system implementing DO according to embodiments of the invention is shown in FIG. 1. As shown, the system includes a distribution point unit (DPU) 100 having a full RO vectoring group of N lines 102-1 to 102-N respectively coupled to CPEs 104-1 to 104-N. Of this full set of N lines, a subset of M lines (102-1 of M to 102-M) is designated by the CO as belonging to a DO group.

As is known, during each TDD frame of the G.Fast system (e.g. comprising 36 symbols), all N lines in the system participate in RO for a certain number of symbols (e.g. 4 downstream (DS) symbols of 32 DS symbols per TDD frame), while only the M lines in the system (M<N) participate in DO (e.g. 28 DS symbols per TDD frame), during which symbol periods the remaining N-M lines transmit only quiet symbols to save power. As such, the DPU 100 needs to maintain different sets of FEXT coefficients for the RO group (e.g. N×N matrix of FEXT coefficients 110) and for the DO group (e.g. M×M matrix of FEXT coefficients 112). It should be noted that although only one set of coefficients is shown for each group, there typically needs to be different sets of coefficients for upstream and downstream communications. Moreover, it is possible that there can several different DO groups at the same time, or at different times.

During operation, before each symbol period, the DPU 100 engages the appropriate RO matrix 110 or DO matrix 112 to perform vectoring for all of the lines that are active during the subsequent symbol period.

The DO sub-matrix 112 can be initially derived from the RO matrix 110 when the RO matrix 110 is first estimated. Thereafter, as set forth above, in conventional approaches, every time an LMS update is performed for the RO matrix 110, the coefficients in the DO sub-matrix 112 need to be re-derived from the updated RO matrix 110. The LMS updates to the RO matrix 110 are typically based on Sync symbols. According to certain aspects, the present inventors recognize that updates to the coefficients in the smaller DO sub-matrix 112 can be de-coupled from the LMS updates for the full RO matrix 110 by independently performing LMS updates on the DO sub-matrix 112 using data symbols transmitted during DO symbol periods. In the downstream this involves causing the CPE modems to report errors on these DO data symbols, while in the upstream this involves the DPU providing the DO data symbol errors to the VPE.

Embodiments of the invention will now be described in more detail primarily in connection with the downstream operation where the equipment in the distribution point unit (DPU) is all centrally located and the transceivers may be controlled by a central processor in the DPU. The customer premises transceivers are all distributed to different (disparate) locations. Since upstream crosstalk cancellation is done with post cancellation processing in the DPU, discontinuous operation on each line may be rendered autonomous. However, the invention is not limited to downstream operations, and the principles described herein for the downstream may also be applied to the upstream channel using coordinated upstream flow control, for example.

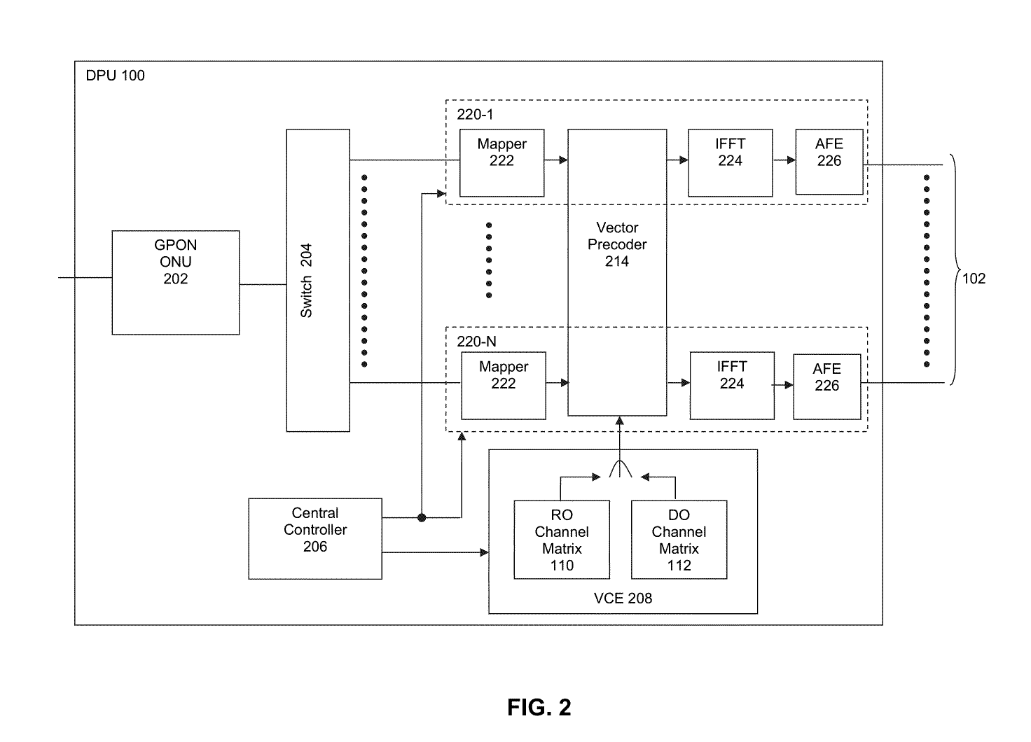

A block diagram illustrating an example DPU 100 for implementing aspects of the present invention is shown in FIG. 2. As shown, DPU 100 includes a fiber optic transceiver (GPON ONU) 202, a switch 204, a central controller 206, a vector control entity (VCE) 208 which maintains a RO channel matrix 110 and a DO channel matrix 112, a vector precoder 214 and N G.fast transceivers 220-1 to 220-N.

As is known, during downstream TDD frames, transceivers 220-j (where j=1, 2, . . . , N) map user data received from GPON ONU 202 and switch 204 to frequency domain symbols using mapper 222 (for each line supported by the DPU). To perform vectoring, vector precoder 214 adjusts the symbols before they are converted to time domain by IFFT 224 and then to analog signals by AFE 226. When DO is enabled, vector precoder 214 uses either RO channel matrix 110 or DO channel matrix 112, as controlled by VCE208. According to aspects of DO, the key elements of FIG. 1 to consider are the G.fast transceivers 120 and the vector precoder 112. The power dissipation of these blocks will be reduced by the DO being enabled.

It should be noted that FIG. 2 illustrates components for downstream transmissions for ease of illustrating aspects of the invention. However, DPU 100 typically also includes components for facilitating upstream communications, as should be apparent to those skilled in the art. Similarly, transceivers 220 are illustrated as including downstream path components such as mapper 222, IFFT 224 and AFE 226 for ease in illustrating certain aspects of the invention as set forth in more detail below. However, it should be understood that transceivers 220 can include additional components not shown in FIG. 2, including components for facilitating both upstream and downstream communications.

Central controller 206, VCE 208, vector precoder 214 can be implemented by processors, chipsets, firmware, software, etc. such as NodeScale Vectoring products provided by Ikanos Communications, Inc. Those skilled in the art will be able to understand how to adapt these and other similar commercially available products after being taught by the present examples.

Meanwhile, G.fast transceivers 220 include conventional processors, chipsets, firmware, software, etc. that implement communication services such as those defined by the G.fast Recommendation, as adapted for use in the present invention. Those skilled in the art will be able to understand how to adapt such conventional G.fast products after being taught by the present examples.

It should be noted that, although shown separately for ease of illustration, some or all of components 206, 208 and 220 may be incorporated into the same chips or chipsets. It should be further noted that, although not illustrated here, transceivers 220 communicate with CPE transceivers also including conventional processors, chipsets, firmware, software, etc. that implement communication services such as those defined by the G.fast standard, as adapted for use in the present invention. Those skilled in the art will be able to understand how to adapt such G.fast products after being taught by the present examples.

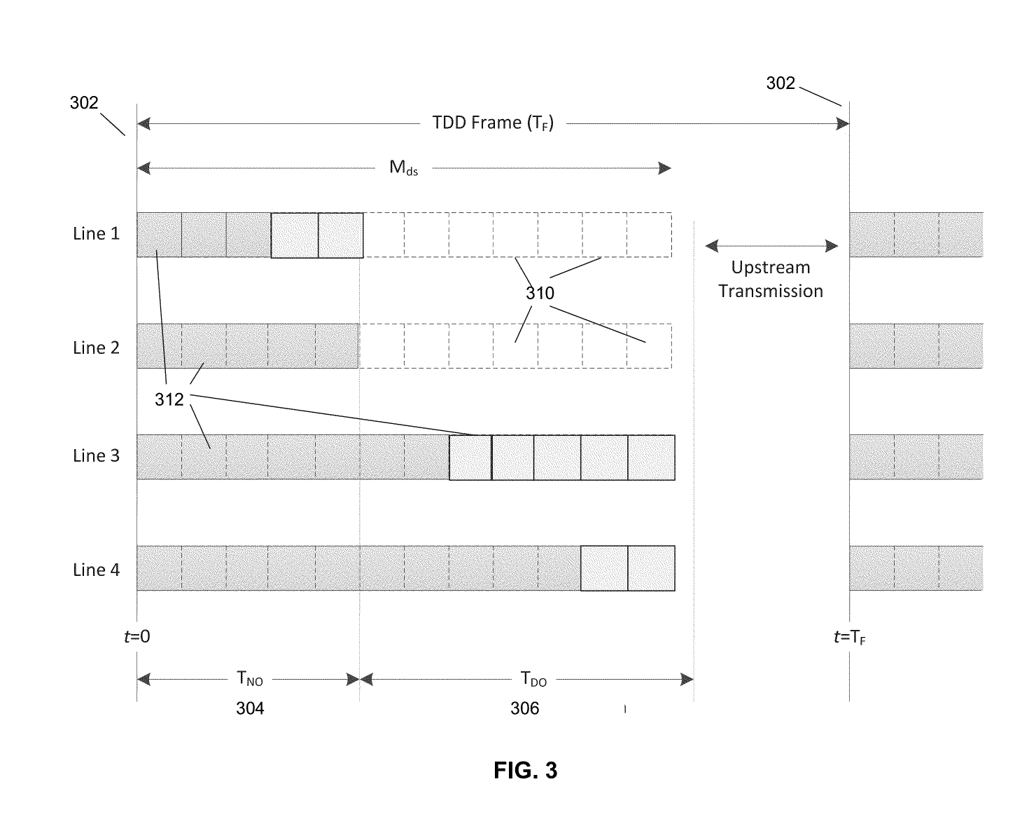

FIG. 3 shows an example of DO being performed when vectoring is enabled in a DPU supporting four lines (i.e. N=4). As shown in this example, to enable vectoring, the TDD frame boundaries 302 are all aligned on all the lines in the vector group. FIG. 3 shows two time regions: T_{NO} 304 for RO where all of the lines in the vector group are transmitting data symbols 312 in each of the time slots; the other region T_{DO} 306 for DO, which has a mixture of lines transmitting data 312 and quiet symbols 310.

It should be noted that, as mentioned previously, descriptions herein focus on transmission in the downstream direction. The crosstalk cancellation in the upstream direction is done with post cancellation processing in the upstream receiver. However, the principles described here for the downstream may also be applied to the upstream channel using coordinated upstream flow control, and so the invention includes such upstream embodiments as well.

It should be further noted that the “transmission” of quiet symbols does not actually involve the formation of any symbols by transceiver 220 nor any transmission of energy on the line. Rather, the transceiver is merely biased in such a manner as to maintain the same termination impedance it has on the line when it is transmitting data. Transmission of a quiet symbol effectively turns off the process of the transceiver for the symbol period resulting in power savings relative to the case where the transceiver is sending a data symbol.

In the example of FIG. 3, to enable vectoring, during RO 304, the VCE 208 causes precoder 214 to perform full 4×4 pre-coding for downstream crosstalk cancellation using matrix 110. Thus, the system is operating with full throughput maximum performance, while also dissipating the maximum power dissipation. For the DO region 306, the central controller 206 optimally configures the time slots for proper balance between system performance and power dissipation savings. Accordingly, in this example, during symbol periods in the DO region 306, the central controller 206 causes the VCE 208 to engage the DO channel matrix 112 so that the downstream pre-coder 214 uses a 2×2 configuration for cancelling the crosstalk between lines 3 and 4, while configuring the transceivers 220 for lines 1 and 2 to transmit only quiet symbols. For the 2×2 pre-coder configuration, it can be assumed that some power saving is achieved in the precoder 214 as compared with the full 4×4 configuration for the corresponding period of time since fewer operations were executed.

It should be noted that the configuration of the channel matrix and pre-coder 214, as well as the number of time slots in the DO region 306 can be dependent on the amount of data required for transmission during the TDD frame. The central controller 206 monitors the activity on the transmit buffers in transceivers 220 to help determine the configuration of time slots and the pre-coder. The algorithms used by controller 206 to determine the optimal balance between performance and power dissipation savings can be implementation dependent, and those skilled in the art will be able to implement various such algorithms after being taught by the present examples.

As set forth above, vectoring systems such as G.fast initially perform a full estimation of the RO coefficient matrix 110 every time lines join or leave the vectoring group. The various conventional techniques for initially estimating the full RO coefficient matrix 110 (e.g. using reported error samples or receiver FFT output sample relative to known pilot sequences) are well known to those skilled in the art, and so details thereof will be omitted here for sake of clarity of the invention. Moreover, as set forth above, there are several proposed methods in connection with G.fast for initially deriving the DO coefficient matrix 112 from the initially estimated full RO coefficient matrix 110. Any of these or other conventional techniques can be used to initially derive the DO coefficient matrix 112 after line joining or leaving events, and so further details thereof will also be omitted here for sake of clarity of the invention.

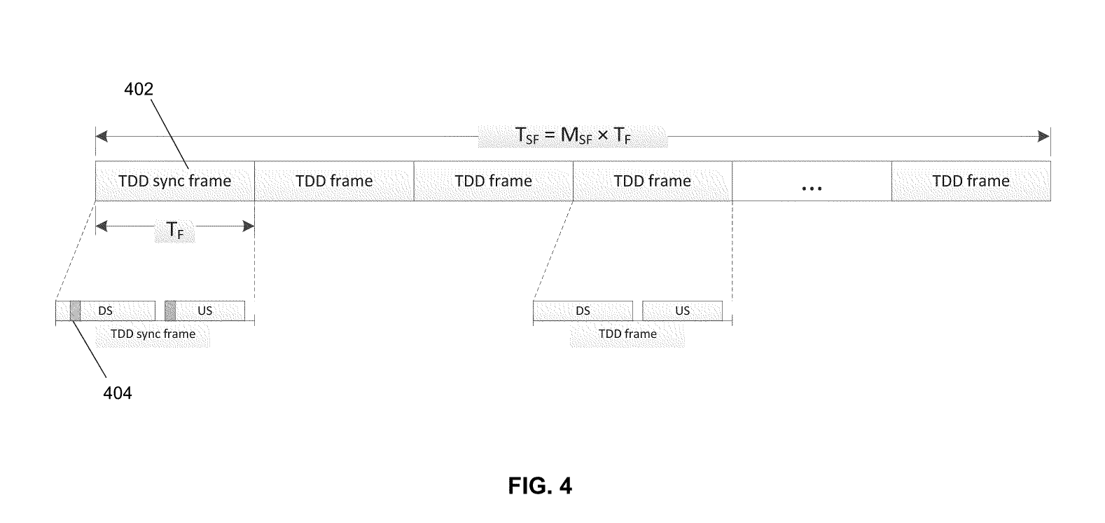

As further set forth above, during Showtime, LMS updates to the RO coefficient matrix 110 are periodically performed to maintain or improve system performance. In one example, these updates are performed using Sync symbols. More particularly, FIG. 4 illustrates the superframe structure of G.fast. As shown, each superframe T_{SF} consists of a plurality of TDD frames T_{F} (e.g. eight), with each TDD frame including downstream (DS) and upstream (US) periods. As further shown, the first frame in each superframe is known as a TDD sync frame 402. The sync frame 402 is the same as other TDD frames except that in each of the downstream and upstream periods a Sync symbol 404 is transmitted. Because the sync symbol of the DS TDD frame will necessarily be transmitted by all lines in the RO group, this Sync symbol 404 can be used to update the full RO coefficient matrix 110.

For example, when the downstream Sync symbol 404 is transmitted by the DPU 100, the CPE transceivers 104 calculate the errors associated with the symbol and transmit the error data back to the DPU 100 in upstream transmission periods using, for example, an embedded operations channel (EOC). Upon receipt of the error data from all the downstream transceivers 104, the VCE 208 can perform an LMS update of the RO coefficient matrix 110 using any of one of a number of well-known LMS mechanisms and algorithms.

In conventional approaches, after performing the LMS update for the RO coefficient matrix 110, the DO coefficient matrix 112 is derived from the updated RO coefficient matrix 110 as described above. Differently from the conventional approaches, according to certain aspects, embodiments of the invention perform updates to the coefficients in the smaller DO sub-matrix 112 independently from the LMS updates for the full RO matrix 110.

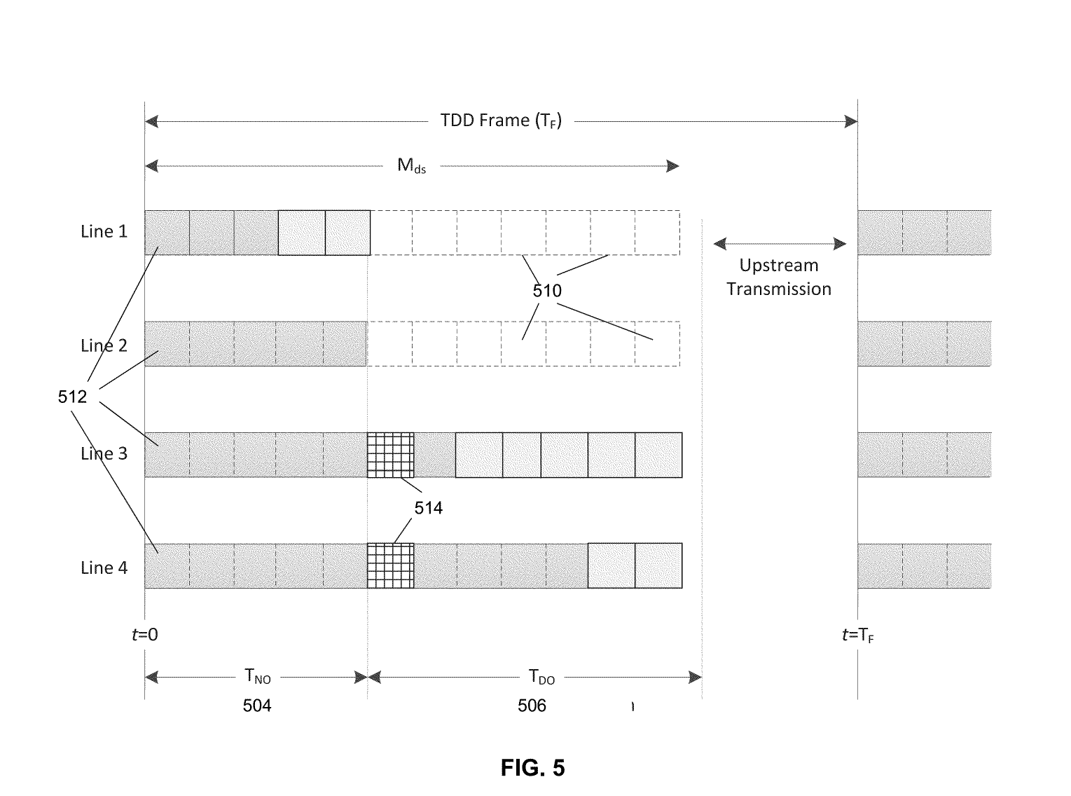

FIG. 5 is a diagram illustrating an example method for updating the DO coefficient matrix 112 according to embodiments of the invention.

As shown in the example of FIG. 5, LMS updates to the DO coefficient matrix 112 are performed during any TDD frame, in addition to and independently to the updates to the RO coefficient matrix 110. This can be done as frequently as every TDD Sync frame, similar to the LMS updates to the RO coefficient matrix. However, this is not necessary, and the updates can be performed less frequently, or on an ad hoc basis. In embodiments, the DPU communicates the timing and parameters for performing the DO LMS updates to the downstream CPE transceivers associated with the DO group of lines using an embedded operations channel (EOC).

For example, FIG. 5 shows a typical TDD frame in which the central controller causes data symbols 512 to be transmitted downstream on all of lines 1-4 during the RO period 504. FIG. 5 also shows how after the RO period 504, the central controller, during DO period 506, causes lines 1 and 2 to transmit quiet symbols 510, while the DO group of lines 3 and 4 transmit data symbols 512.

Differently from conventional approaches, however, during the DO period 506, the controller 206 causes the transceivers 220 for lines 3 and 4 to keep track of data symbols 514 transmitted in the first symbol period of the DO period 506. These data symbols 514 can be random and entirely based on user data for lines 3 and 4, for example.

Upon receiving these symbols 514, and having been informed of them by the central controller using a downstream EOC for example, the downstream CPE modems calculate the errors in them. The downstream CPE modems then report the errors to DPU 100 during subsequent upstream transmission periods using, for example, an upstream embedded operations channel (EOC) to the central controller, which decodes them and sends them to the VCE 208. Using these errors, the VCE 208 performs an LMS update to the DO coefficient matrix 112 using any one of a number of well-known LMS mechanisms and algorithms. It should be noted that the processing to perform the LMS updates to either or both of the RO and DO coefficient matrices may take many symbol periods or TDD frames, in which case the updated matrices may not be engaged right away.

It should be apparent that similar processing as described above could be performed for an upstream DO coefficient matrix using data symbols transmitted upstream to the DPU 100 from the CPE modems associated with the DO group.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

1. A method for managing a set of Far-End Cross Talk (FEXT) coefficients for a Discontinuous Operation (DO) group of lines in a G.fast communication system, comprising:
during a DO transmission period, transmitting symbols on the DO group of lines; and
performing a least mean squares (LMS) update of the set of FEXT coefficients based on the symbols transmitted during the DO transmitted period.

2. A method according to claim 1, wherein the G.fast communication system further includes a separate set of FEXT coefficients for a Regular Operation (RO) group of lines, and wherein updating the set of FEXT coefficients for the DO group of lines is performed independently from LMS updates to the separate set of FEXT coefficients for the RO group of lines.

3. A method according to claim 1, wherein the symbols for performing the LMS update of the set of FEXT coefficients are data symbols for user data associated with the DO group of lines.

4. A method according to claim 2, wherein the set of FEXT coefficients for the DO group of lines is initially derived from the separate set of FEXT coefficients for the RO group of lines.

5. A method according to claim 1, wherein performing includes receiving error data from modems that receive the symbols on the DO group of lines and using the error data to perform the LMS update.

6. A G.fast communication system, comprising:
a Regular Operation (RO) group of lines, a subset of which are designated as a Discontinuous Operation (DO) group of lines;
a set of Far-End Cross Talk (FEXT) coefficients for the DO group of lines;
a central controller that causes, during a DO transmission period, symbols to be transmitted on the DO group of lines; and
a vector control entity (VCE) that performs a least mean squares (LMS) update of the set of FEXT coefficients based on the symbols transmitted during the DO transmitted period.

7. A G.fast communication system according to claim 6, further comprising a separate set of FEXT coefficients for the RO group of lines, wherein updating the set of FEXT coefficients for the DO group of lines is performed independently from LMS updates to the separate set of FEXT coefficients for the RO group of lines.

8. A G.fast communication system according to claim 6, wherein the symbols for performing the LMS update of the set of FEXT coefficients are data symbols for user data associated with the DO group of lines.

9. A G.fast communication system according to claim 7, wherein the set of FEXT coefficients for the DO group of lines is initially derived from the separate set of FEXT coefficients for the RO group of lines.

10. A G.fast communication system according to claim 6, wherein the central controller receives error data from modems that receive the symbols on the DO group of lines and forwards them to the VCE to use the error data to perform the LMS update.
